(19) United States
(12) Patent Application Publication
(10) Pub. No.: US 2026/0179116 A1
(43) Pub. Date: Jun. 25, 2026

(54) Methods, Systems, and Apparatus for Managing Collections of Collectibles

(71) Applicant: Dynamics Inc., Cheswick, PA (US)

(72) Inventors: Jeffrey D. Mullen, Glenshaw, PA (US); Brian E. Schuliger, Wexford, PA (US); Andrew Veter, Pittsburgh, PA (US)

(21) Appl. No.: 19/257,259

(22) Filed: Jul. 1, 2025

Related U.S. Application Data
(63) Continuation of application No. 14/032,384, filed on Sep. 20, 2013, now abandoned.
(60) Provisional application No. 61/703,954, filed on Sep. 21, 2012.

(51) Int. Cl. G06Q 30/0207

(52) U.S. Cl. CPC G06Q 30/0222

(57) ABSTRACT

Systems, methods, and apparatus for managing collections of collectibles for users are disclosed. The collections can be digital collections, physical collections, and/or physical collections that are physically stored in a third-party vault while being managed via an associated digital collection that includes actual images of the physical collectibles. The systems, methods, and apparatus enable a user to quickly and easily identify which collectibles are possessed and which are not in a given collection.

### CROSS-REFERENCE TO RELATED APPLICATION

This application claims the benefit of U.S. Provisional Patent Application No. 61/703,954 , titled “CARDS, DEVICES, SYSTEMS, ECOSYSTEMS, APPLICATIONS AND RANDOM REWARDS,” filed Sep. 21, 2012 (Attorney Docket No. D/120 PROV), which is hereby incorporated by reference herein in its entirety.

### BACKGROUND OF THE INVENTION

This invention relates to magnetic cards, devices and payment systems.

### SUMMARY OF THE INVENTION

Systems and methods are provided for allowing a user to select an additional service to be performed in addition to the payment of goods with a payment card or other device (e.g., a mobile telephonic device, a tablet computer device, or another electronic device). A card, or other device, may include one or more buttons. A user may associate an additional service to a button of a card at any time. At the time of purchase, information indicative of the button the user selected may be passed to a point-of-sale system with a user's payment information. Such data may be, for example, communicated through a merchant acquirer's network to a processing facility.

The processing facility may, for example, authorize a payment transaction and forward the information indicative of the button a user selected and the identity of a user to a remote facility. Such a remote facility may, for example, forward at least some of such information, as well as additional information, to a third party service provider such that the third party service provider enacts the additional feature desired by the user.

Such an additional feature may include, for example, a random game action in an online game by a game service provider, redemption of a random coupon or voucher by a third party coupon provider, earning of a random number of loyalty points from a third party loyalty service, and/or the like.

Selection of a feature may be provided, for example, by a Graphical User Interface (GUI) provided on a computing device (e.g., a mobile telephonic device) as a software and/or hardware application for that device, and/or via the internet or an intranet through a web brows. Such a selection may be provided with a non-powered card such that a single feature may be associated with a card for a period of time. Such a selection may be associated to an option (e.g., a button) on a powered card or other device (e.g., a mobile telephonic device) such that the user may associate different features with different options (e.g., different buttons).

Accordingly, for example, a user may receive a powered card, or other device, in the mail and use his/her web browser to associate different additional features to different buttons. The user may then utilize the card in a store and press a button in order to select that feature. A card, or other device, may download information (e.g., via a wireless communication such as a light or electromagnetic communication) such that the card, or other device, displays information next to an option indicative of the feature (e.g., “Redeem LivingSocial Voucher,” “Facebook Like”). Alternatively, no download may be provided and no additional information may be displayed such that a user's card, or other device, includes a generic descriptor (e.g., “credit” and “feature,” or “feature 1” and “feature 2,” or “debit” and “feature 1” and “feature 2”).

A remote facility may also receive additional information than just a user identifier and information indicative of the option selected by a user (or that the user made a payment). Such additional information may be, for example, the type of merchant (e.g., a retail merchant or a gas merchant), the location of a merchant (e.g., the zip code of a merchant), the type of transaction (e.g., online or in-store purchase), the name of the merchant (e.g., “Amazon. com,” or “Walmart”), the amount of the transaction (e.g., $10.25), and any other information. Such a remote facility may forward such information to a third party service provider in addition to information generated by the remote facility (e.g., a second user identifier such that different identifiers are used with the facility sending payment information and the third party service provider).

A feature/payment method ecosystem may be provided in which a development kit is available for third parties to develop applications for payment cards or other devices. A GUI may be provided where a user can select different third party applications to be associated with one or more user payment methods. The third party applications may be approved by an administrator before being accessible by a GUI. Different categories of third party applications may be provided on the GUI (e.g., a coupon category, a check-in category, a games category, a financial management tools category). The development kit may provide the ability for a third party service provider to, for example, receive user identification numbers and other information, (e.g., merchant name and location) and provide particular information (e.g., within a period of time) to a remote facility.

Information received from a third party service provider may include, for example, information indicative that the user was properly identified and a service was performed (e.g., “check-in completed,” “information added to financial management service.”). Such information may be provided back to an issuing bank, processor, or other service provider such that the information may be displayed on a user's billing statement. Additional information may also be provided that may change the way a transaction is authorized or settled.

Additional information received from a third party may be utilized to change the way a transaction is authorized or settled. For example, a third party may provide a user with the ability to pre-purchase a voucher to a particular store (e.g., a particular barber in a particular zip code). A user may associate this third party service to a button on the user's card. For example, a user may purchase a service at a barber multiple times during a year on the user's credit account. The user may, at one such purchase, press the button associated with the desire to use the third party service and redeem a voucher the user already purchased or acquired. Information indicative of the user's desire to utilize such a service may be communicated to a point-of-sale terminal via a communications device located on the card (e.g., a dynamic magnetic stripe communications device, an RFID antenna, an exposed IC chip (e.g., an EMV chip, or any other communications device). The transaction may be authorized using the user's payment account if, for example, the user has enough funds associated with that account (e.g., a credit or debit account).

The third party service provider may then determine the user had a pre-paid voucher for the transaction and may return to the card issuer, processor, or other party information indicative that the user's bill is to be adjusted by the amount of the voucher. Before, or after, settlement occurs a user's bill may show a statement credit in the amount of the voucher. A remote facility may perform such a data exchange as well as any associated value exchange. For example, the remote facility may, for a fee (e.g., a percentage of a transaction or a fixed fee), provide value from the third party service provider to the card issuer or processor (e.g., via an ACH or other type of monetary transaction).

Alternatively, for example, the remote facility may provide the desired value to the card issuer, processor, or other party and demand the associated value be paid to the remote facility by the third party service provider within a period of time (e.g., three days). Information provided by a third party service provider to a remote facility may include an identifier indicative of the third party service provider, an identifier indicative of the user, an identifier indicative of the type of service provided by the third party service provider, an identifier indicative of the transaction with which further action by the third party service provider is desired, an amount of a post-statement credit that is to be applied for a particular transaction, and amount of a post-settlement credit that is to be applied for a particular transaction, an amount of a pre-settlement credit that is to be applied for a particular transaction, an amount of a credit that is to be applied during an authorization, an additional fee to be added to a statement for an additional service (e.g., a fee-based financial management tool service), and any other information desired by the third party service provider, processor, card issuer, remote facility, device provider, or any other entity (e.g., a card network).

Information indicative of a button press, or use of a card, that triggers a feature may be provided in a payment message utilized at authorization or at settlement. Furthermore, the service provider may return information in a period of time that permits actions to be performed pre-authorization or pre-settlement.

The payment actions may be determined, for example, via a user interaction with the card. Particularly, for example, a user may press a button on the card, from a group of buttons, the button being associated with the third party feature. The third party feature may be unique from the features provided to the user via the third party's non-payment card or device services. Accordingly, a user may obtain the benefit of the whimsical and festive nature of a unique feature every time the user makes a payment.

Information indicative of feature selection may be provided, for example, via an output device operable to be read by a card reader. For example, the feature may be provided by a dynamic magnetic stripe communications device, an RFID antenna, an exposed IC chip, or any other type of card reader. For online purchases, for example, a display may be provided on the card and a user selection may cause a particular number (e.g., a particular code) to be displayed on the card. Such a code may be entered into a text box on a website at checkout and may be representative of the user's desired feature. Accordingly, the feature may be communicated to a remote server such that the feature may be performed in the third party service on behalf of the user. The code may additional provide the benefits of a security code and may be entered with a payment card number (e.g., a credit or debit card number) at online or in-store checkout.

Rewards may be awarded based on the amount of a purchase. Such rewards may be associated with a third party service or a card issuer, device or card provider, or other entity. For example, a random reward may be awarded by an application provider at every purchase instead of a card issuer providing an amount of points, miles, or cashback to a user. Alternatively, for example, a user may earn both rewards from a card issuer as well as rewards from a third party service provider. A user may select, via, for example, physical buttons on the card or virtual buttons on a capacitive-sensitive display of a mobile telephonic device, the type of feature the user desires. Multiple features may be provided from a particular third party service provider. For example, a game service provider may provide a feature associated with one game action and another feature associated with another game action.

A card may include a dynamic magnetic communications device. Such a dynamic magnetic communications device may take the form of a magnetic encoder or a magnetic emulator. A magnetic encoder may change the information located on a magnetic medium such that a magnetic stripe reader may read changed magnetic information from the magnetic medium. A magnetic emulator may generate electromagnetic fields that directly communicate data to a magnetic stripe reader. Such a magnetic emulator may communicate data serially to a read-head of the magnetic stripe reader.

All, or substantially all, of the front as well as the back of a card may be a display (e.g., bi-stable, non bi-stable, LCD, LED, or electrochromic display). Electrodes of a display may be coupled to one or more capacitive touch sensors such that a display may be provided as a touch-screen display. Any type of touch-screen display may be utilized. Such touch-screen displays may be operable of determining multiple points of touch. Accordingly, a barcode may be displayed across all, or substantially all, of a surface of a card. In doing so, computer vision equipment such as barcode readers may be less susceptible to errors in reading a displayed barcode.

A card may include a number of output devices to output dynamic information. For example, a card may include one or more RFIDs and/or IC chips to communicate to one or more RFID readers or IC chip readers, respectively. According to some example embodiments, a card may include three or more different types of output devices. A card may include devices to receive information. For example, an RFID and IC chip may both receive information and communicate information to an RFID and IC chip reader, respectively.

A device for receiving wireless information signals may be provided. A light sensing device and/or sound sensing device may be utilized to receive information wirelessly. A card may include a central processor that communicates data through one or more output devices simultaneously (e.g., an RFID, IC chip, and a dynamic magnetic stripe communications device). The central processor may receive information from one or more input devices simultaneously (e.g., an RFID, IC chip, dynamic magnetic stripe devices, light sensing device, and a sound sensing device). A processor may be coupled to surface contacts such that the processor may perform the processing capabilities of, for example, an EMV chip. The processor may be laminated over and not exposed such that such a processor is not exposed on the surface of the card.

A card may be provided with a button in which the activation of the button causes a code to be communicated through a dynamic magnetic stripe communications device (e.g., the subsequent time a read-head detector on the card detects a read-head). The code may be indicative of, for example, a feature (e.g., a payment feature). The code may be received by the card via manual input (e.g., onto buttons of the card) or via a wireless transmission (e.g., via light, electromagnetic communications, sound, or other wireless signals). A code may be communicated from a webpage (e.g., via light and/or sound) to a card. A card may include a display such that a received code may be visually displayed to a user. In doing so, the user may be provided with a way to select, and use, the code via both an in-store setting (e.g., via a magnetic stripe reader) or an online setting (e.g., by reading the code from a display and entering the code into a text box on a checkout page of an online purchase transaction).

A remote server, such as a payment authorization server, may receive the code and may process a payment differently based on the code received. For example, a code may be a security code to authorize a purchase transaction. A code may provide a payment feature such that a purchase may be made with points, debit, credit, installment payments, or deferred payments via a single payment account number (e.g., a credit card number) to identify a user and a payment feature code to select the type of payment a user desires to utilize.

A dynamic magnetic stripe communications device may include a magnetic emulator that comprises an inductor (e.g., a coil). Current may be provided through this coil to create an electromagnetic field operable to communicate with the read-head of a magnetic stripe reader. The drive circuit may fluctuate the amount of current travelling through the coil such that a track of magnetic stripe data may be communicated to a read-head of a magnetic stripe reader. A switch (e.g., a transistor) may be provided to enable or disable the flow of current according to, for example, a frequency/double-frequency (F2F) encoding algorithm. In doing so, bits of data may be communicated.

Electronics may be embedded between two layers of a polymer (e.g., a PVC or non-PVC polymer). One or more liquid polymers may be provided between these two layers. The liquid polymer(s) may, for example, be hardened via a reaction between the polymers (or other material), temperature, and/or via light (e.g., an ultraviolet or blue spectrum light) such that the electronics become embedded between the two layers of the polymer and a card is formed.

A payment card or other device may receive information indicative of a feature desired to be added by a user. The payment card may communicate information indicative of the feature with payment card data associated with the card or a user selection. The payment data and feature information may be routed, for example, to an authorization server. The authorization server may authorize payment and, based on the authorized payment, communicate the feature information to a remote server. The remote server may utilize this remote information to impact a third party service. The feature information may, for example, be routed before the payment card data reaches an authorization server. At merchant settlement, charge backs for a purchase associated with a random reward may cause the feature to be reversed or a different feature to be implemented (e.g., a removal of rewards earned at authorization). The feature may be implemented at settlement upon confirmation that, for example, no chargeback was associated with the payment transaction.

A graphical user interface (GUI) may be provided to allow users to display one or more application managers and one or more application provider interfaces. The GUI may be rendered onto a display of a device (e.g., a powered card, a mobile telephonic device, an electronic tablet, a laptop computer, or a desktop computer) and may allow a user to configure features that are desired to be added by the user.

A user may, for example, associate a device or card with one or more third party service features using the application manager. Such an application manager may be an interface to an ecosystem of applications and payment method cards where users within the ecosystem may manage which application(s) may be associated with a particular payment method card. A user may alter such associations at any time. Prior to associating one or more applications to a particular payment method card, the payment method card may be associated with one or more default applications that may be later modified by the user.

A GUI may be provided on an electronic device to administer a third party application that facilitates the provision of random rewards. The random rewards may be earned by a user upon completion of a performance metric. The reward may be selected randomly from every award made available by an application and/or feature provider, and/or the reward may be randomly selected from a subset of rewards. For example, an application provider may be a music provider such as a recording studio and/or a music distributor. A user of a payment method, for example a powered card, may earn a random song each time the user spends an target amount of money using the powered card. The song may be randomly selected from among all songs made available by the music provider, the song may be randomly selected from a music genre chosen by the user and/or the like.

A collection from which a reward may be randomly selected may be any pool of two or more rewards. For example, where a feature provider is a music provider, a song may be randomly selected from a song genre, new songs, songs by an artist, songs from a time period, regional songs, and/or songs belonging to a song type. Earned rewards may be removed from a collection such that the user does not receive a repeat reward, or a repeat reward may be possible.

A type of reward provided to a user may be any type of reward. For example, a reward may be an audiovisual reward, a charitable reward, a tangible reward, and/or a service. A collection may include one type of reward or may be a mix of various different types of rewards. A collection may include rewards that exist and/or that are intended to exist at some time in the future.

A performance metric may include, for example, a purchase with a card (e.g., a physical and/or device card), a sequence of purchases (e.g., ten purchases), a total amount spent, and/or other metrics related to various purchasing and/or non-purchasing transactional events.

A reward may scale based on an associated performance metric. The greater the burden placed on a user by a performance metric, the greater the reward may be. For example, a random television show may be earned from all shows produced by a television network each time a user makes purchases meeting or exceeding a specific dollar amount. For a dollar amount exceeding the specific dollar amount, a user may instead select a reward (e.g., non-random) or additional value may be provided (e.g., a season of television shows).

### BRIEF DESCRIPTION OF THE DRAWINGS

The principles and advantages of the present invention can be more clearly understood from the following detailed description considered in conjunction with the following drawings, in which the same reference numerals denote the same structural elements throughout, and in which:

FIG. 1 is an illustration of a card and architecture constructed in accordance with the principles of the present invention;

FIG. 2 is an illustration of a device constructed in accordance with the principles of the present invention;

FIG. 3 is an illustration of a network topology constructed in accordance with the principles of the present invention;

FIG. 4 is an illustration of a device constructed in accordance with the principles of the present invention;

FIG. 5 is an illustration of a device constructed in accordance with the principles of the present invention;

FIG. 6 is an illustration of a process flow chart constructed in accordance with the principles of the present invention;

FIG. 7 is an illustration of a device constructed in accordance with the principles of the present invention; and

FIG. 8 is an illustration of a device constructed in accordance with the principles of the present invention.

### DETAILED DESCRIPTION OF THE INVENTION

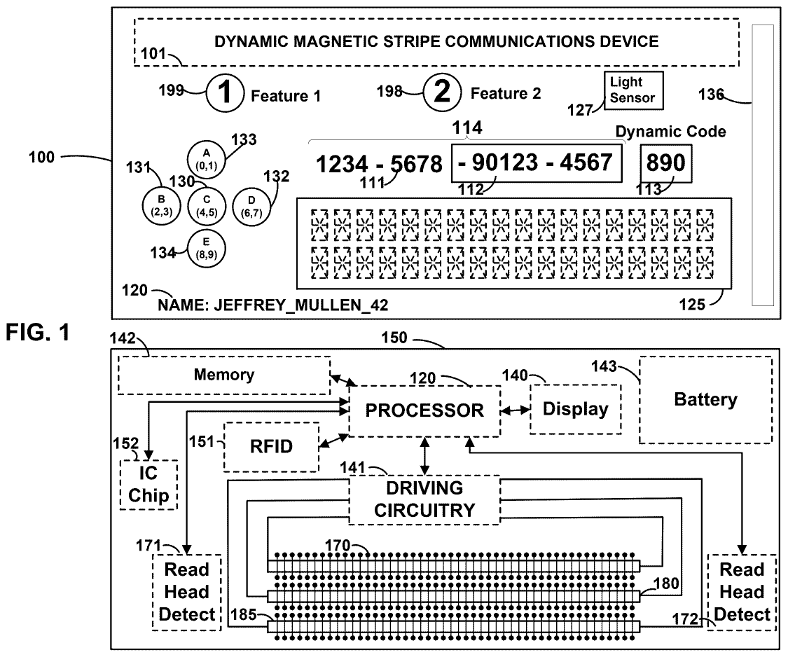

FIG. 1 shows card 100 that may include, for example, dynamic magnetic stripe communications device 101, one or more displays (e.g., displays 112, 113 and 125), permanent information 120, light sensor 127, temperature sensor 136, one or more buttons (e.g., buttons 130-134, 198 and 199) and dynamic number 114 which may include a permanent portion 111. Permanent portion 111 may be, for example, printed, embossed and/or laser etched on card 100.

Multiple displays may be provided on card 100 for various purposes. For example, display 112 may display a dynamic number entirely, and/or partially. Display 113 may be utilized to display a dynamic code (e.g., a dynamic security code). Display 125 may display logos, barcodes, and/or one or more lines of information (e.g., may display a temperature). A display (e.g., at least one of displays 112, 113 and 125) may be a bi-stable display or non bi-stable display. A bi-stable display may be a display that maintains an image without power.

Card 100 may include permanent information 120 including, for example, information specific to a user (e.g., a user's name and/or username) and/or information specific to a card (e.g., a card issue date and/or a card expiration date).

Card 100 may include one or more buttons, for example, buttons 130-134. Buttons 130-134 may be mechanical buttons, capacitive buttons, or a combination of mechanical and capacitive buttons. Card 100 may include button 199. Button 199 may be used, for example, to communicate information through dynamic magnetic stripe communications device 101 indicative of a user's desire to communicate a single track of magnetic stripe information. Persons skilled in the art will appreciate that pressing a button (e.g., button 199) may cause information to be communicated through device 101 when an associated read-head detector detects the presence of a read-head of a magnetic stripe reader and/or at a specific frequency.

Button 198 may be utilized to communicate (e.g., after button 198 is pressed and after a read-head detects a read-head of a reader) information indicative of a user selection (e.g., to communicate two tracks of magnetic stripe data). Multiple buttons may be provided on a card and each button may be associated with a different user selection.

Button 198 and button 199 may each be associated with, for example, a different third party service provider feature (e.g., an application facilitating a random reward) and may be changed by a user at any time.

A third party feature associated with a button may be changed by a user, for example, on a graphical user interface (GUI) provided by a device provider, ecosystem provider, application manager provider, remote facility provider, card issuer, processor, and/or any other entity (which may be the same or different entities). For example, an ecosystem provider may, on its website and/or via an application, allow a user to change the third party feature performed when the third party's feature button is selected by a user on the user's card or other device.

For example, suppose a third party service provider provides a random reward from a collection of rewards and then presents the fact the user has received the random reward on a profile page of the user. When a transaction is performed, a user's profile may be updated to state that the user has been awarded a reward and the user may receive the reward (e.g., via email). A user may be provided with a GUI, for example, a GUI on a mobile telephonic device of the user when the user makes a purchase, to identify the random reward earned by the user.

The selection of a feature may or may not have a cost associated with it. If a cost is associated with the feature, for example, the cost may be added to a customer's statement (e.g., added to a credit or debit purchase) for a particular transaction. A fixed-fee or variable-fee (e.g., a percentage of the transaction) may then be removed from the fee charged to the user and distributed among particular parties (e.g., distributed among the card issuer, application manager provider, ecosystem provider, device provider and/or other entity). The remainder of the fee may be provided, for example, to the third party service provider.

A cost may be associated to a feature selection, but may not be a cost to a user. For example, the cost may be a cost to a third party service provider (e.g., an incentive). The cost may be a cost to other entities, for example, the device provider, card issuer, card processor (which may be the same, for example, as the card issuer), and/or any other entity (e.g., card network).

Card 100 may include light sensor 127. Light sensor 127 may, for example, receive information from a light source (e.g., a display of a mobile telephonic device and/or a laptop computer). Card 100 may include, for example, any number of light sensors 127. Light sensor 127 may be utilized such that a display screen, or other light emitting device, may communicate information to light sensors 127 via light. Display 125 may allow a user to select (e.g., via buttons) options on display 125 that instruct the card to communicate (e.g., via a dynamic magnetic stripe communications device, RFID and/or exposed IC chip) to use a debit account, credit account, pre-paid account, and/or point account for a payment transaction.

Temperature sensor 136 may, for example, detect a card temperature. For example, temperature sensor 136 may determine a temperature of a card 100 and communicate the temperature to a processor. Various parameters of the card may be adjusted based on the communicated temperature. For example, current and/or voltage provided to a dynamic magnetic stripe communications device may be automatically adjusted. One of ordinary skill will appreciate that a card temperature may alter characteristics of a card in a variety of ways and change the way the card functions. One of ordinary skill will appreciate that various parameters may be adjusted to compensate for a temperature related alteration of card characteristics.

Although FIG. 1 illustrates temperature sensor 136 as a rectangle on an edge of a card, such illustration is for purposes of explanation only. Temperature sensor 136 may be included in a variety of types and/or configurations, and may be provided in a variety of shapes and locations. Multiple temperature sensors 136 may be included. Temperature sensor 136 may determine a card temperature and/or a temperature of an individual component (e.g., a temperature of an IC chip, a dynamic magnetic stripe communication device and/or the like).

Architecture 150 may be utilized with any card (e.g., any card 100). Architecture 150 may include, for example, processor 120, display 140, driving circuitry 141, memory 142, battery 143, radio frequency identification (RFID) 151, integrated circuit (IC) chip 152, electromagnetic field generators 170, 180, and 185, and read-head detectors 171 and 172.

Processor 120 may be any type of processing device, for example, a central processing unit (CPU) and/or a digital signal processor (DSP). Processor 120 may be, for example, an application specific integrated circuit (ASIC). Processor 120 may include on-board memory for storing information (e.g., drive code). Any number of components may communicate to processor 120 and/or receive communications from processor 120. For example, one or more displays (e.g., display 140) may be coupled to processor 120. Persons skilled in the art will appreciate that components may be placed between particular components and processor 120. For example, a display driver circuit may be coupled between display 140 and processor 120.

Memory 142 may be coupled to processor 120. Memory 142 may store data, for example, data that is unique to a particular card. Memory 142 may store any type of data. For example, memory 142 may store discretionary data codes associated with buttons of a card (e.g., card 100 of FIG. 1). Discretionary data codes may be recognized by remote servers to effect particular actions. For example, a discretionary data code may be stored in memory 142 and may be used to cause a third party service feature to be performed by a remote server (e.g., a remote server coupled to a third party service such as a random reward provider).

Different third party features may be, for example, associated with different buttons and a particular feature may be selected by pressing an associated button. According to some example embodiments, a user may select a third party feature from a list displayed to the user. For example, the user may scroll through a list of features on a display (e.g., a display on the front of the card). A user may scroll through a list using buttons on a card (e.g., card 100 of FIG. 1). The list of features may be displayed to the user individually (e.g., one or more buttons may be used to change which feature is displayed), in groups and/or all features may be simultaneously displayed.

According to at least one example embodiment, a user may select a type of payment on card 100 via manual input interfaces. The manual input interfaces may correspond to displayed options (e.g., displayed on display 125). Selected information may be communicated to a magnetic stripe reader via a dynamic magnetic stripe communications device. Selected information may also be communicated to a device (e.g., a mobile telephonic device) including a capacitive sensor and/or other type of touch sensitive sensor.

Architecture 150 may include any number of reader communication devices. For example, architecture 150 may include at least one of IC chip 152, RFID 151 and a magnetic stripe communications device. IC chip 152 may be used to communicate information to an IC chip reader (not illustrated). IC chip 152 may be, for example, an EMV chip. RFID 151 may be used to communicate information to an RFID reader. RFID 151 may be, for example, an RFID tag. A magnetic stripe communications device may be included to communicate information to a magnetic stripe reader. For example, a magnetic stripe communications device may provide electromagnetic signals to a magnetic stripe reader.

Different electromagnetic signals may be communicated to a magnetic stripe reader to provide different tracks of data. For example, architecture 150 may include electromagnetic field generators 170, 180, and 185 to communicate separate tracks of information to a magnetic stripe reader. Electromagnetic field generators 170, 180, and 185 may include a coil (e.g., each may include a coil) wrapped around one or more materials (e.g., a soft-magnetic material and a non-magnetic material). Each electromagnetic field generator may communicate information, for example, serially to a receiver of a magnetic stripe reader for a particular magnetic stripe track. According to at least one example embodiment, a single coil may communicate multiple tracks of data.

Card 100 may include a dynamic magnetic communications device. Such a dynamic magnetic communications device may take the form of a magnetic encoder or a magnetic emulator. A magnetic encoder may change the information located on a magnetic medium such that a magnetic stripe reader may read changed magnetic information from the magnetic medium. A magnetic emulator may generate electromagnetic fields that directly communicate data to a magnetic stripe reader. Such a magnetic emulator may communicate data serially to a read-head of the magnetic stripe reader.

Architecture 150 may include read head detectors 171 and 172. Read-head detectors 171 and 172 may be configured to sense the presence of a magnetic stripe reader (e.g., a read-head housing of a magnetic stripe reader). Information sensed by the read-head detectors 171 and 172 may be communicated to processor 120 to cause processor 120 to communicate information serially from electromagnetic generators 170, 180, and 185 to magnetic stripe track receivers in a read-head housing of a magnetic stripe reader.

According to at least one example embodiment, a magnetic stripe communications device may change the information communicated to a magnetic stripe reader at any time. Processor 120 may, for example, communicate user-specific and card-specific information through RFID 151, IC chip 152, and/or electromagnetic generators 170, 180, and 185 to card readers coupled to remote information processing servers (e.g., purchase authorization servers). Driving circuitry 141 may be utilized by processor 120, for example, to control electromagnetic generators 170, 180 and 185.

Architecture 150 may include, for example, a light sensor. Architecture 150 may receive information from a light sensor. Processor 120 may determine information received by a light sensor.

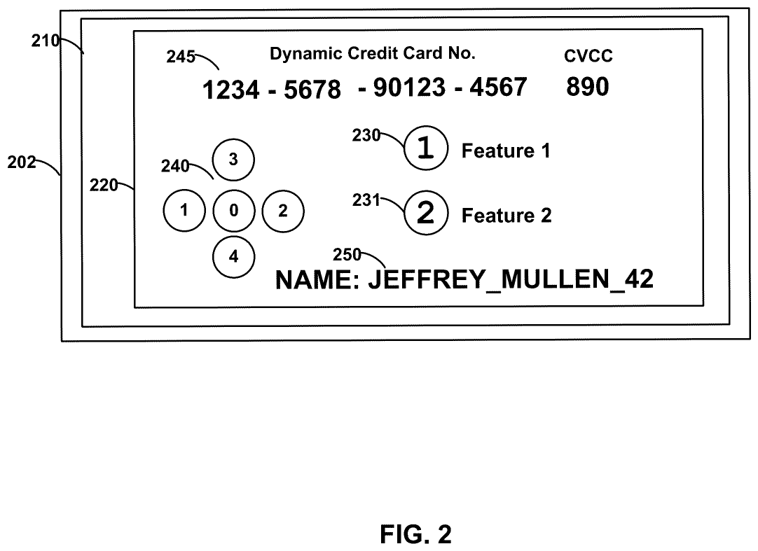

FIG. 2 shows device 200 that may be, for example, a mobile telephonic device and/or other device (e.g., portable computer such as a portable tablet computer). Device 200 may include, for example, housing 202, display 210, device card 220, virtual buttons 230, 231 and 240, dynamic card number and verification code 245 and identification information 250.

Display 210 may include, for example, light-sensitive and/or touch-sensitive elements. Device 200 may communicate information to a card reader, for example, via a contactless signal (e.g., an RFID signal) and/or a contact-based signal (e.g., a USB connection).

Device 200 may include a device card 220 and/or virtual buttons 230 and 231. Device card 220 may be a virtual representation of a card and/or any information identifying a payment method (e.g., credit account number). A person skilled in the art will appreciate that any physical card described herein may be provided as a device card on, for example, a computing system (e.g., a mobile telephonic device and/or a computer). Physical buttons of a physical card may, for example, correspond to virtual buttons of a device card.

Virtual button 230 may, for example, correspond to one feature (e.g., an opportunity to earn a random reward) from one third party service provider while virtual button 231 may, for example, correspond to another feature (e.g., the opportunity to win a different random reward) from another third party service provider. According to at least one example embodiment, every feature may not be provided by a third party service provider. Persons skilled in the art will appreciate that, for example, the device provider may provide features.

All features for a card may be utilized with a particular payment account (e.g., a credit account) such that a payment transaction with that payment account is performed if any feature is selected. As another example, one or more features may be associated with a payment account (e.g., a credit account) while an additional one or more features may be associated with a different payment account (e.g., a debit account). Accordingly, a selected feature associated with a credit account may be utilized to make a purchase with credit and may perform an additional action associated with that feature. A different selected feature associated with a debit account may be utilized to make a purchase with debit and may perform an additional action associated with that different feature.

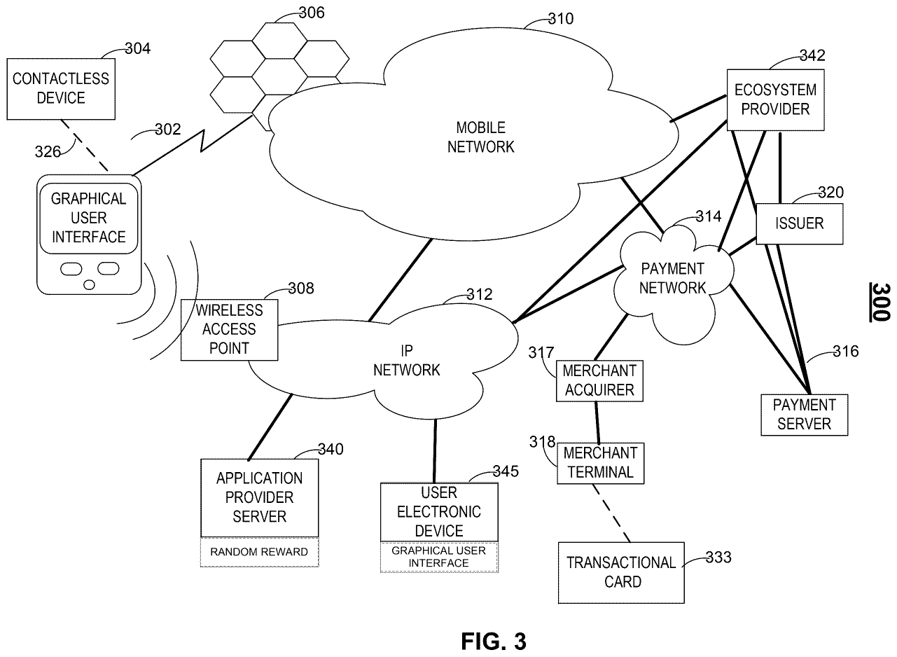

FIG. 3 shows network topology 300 that may include, for example, mobile device 302, contactless device 304, cellular network access infrastructure 306, mobile network 310, wireless access point 308, IP network 312, payment network 314, issuer 320, payment server 316, merchant acquirer 317, ecosystem provider 342, merchant terminal 318, transaction card 333, user electronic device 345 and/or application provider 340.

Mobile device 302 (e.g., a mobile telephonic device, a PDA, an electronic tablet, a laptop, a GPS unit, and/or an MP3 player) may include, for example, a contactless interface that may initiate, sustain, and/or terminate communication channel 326 between contactless device 304 (e.g., a powered card, non-powered card and/or a device) and mobile device 302. Contactless device 304 and mobile device 302 may communicate via channel 326 using any number of contactless mediums, which may include for example, visible, audible, capacitive, electromagnetic, magnetic, and/or RF mediums.

Mobile device 302 may provide one or more transceivers, receivers and/or transmitters that may communicate with one or more wired networks (e.g., IP network 312 and/or payment network 314) and/or one or more wireless networks (e.g., a mobile network 310). Mobile device 302 may, for example, communicate with a cellular station over a wireless radio interface (e.g., a GSM air interface) that may be used by mobile device 302 to communicate information (e.g., voice and data) to cellular network access infrastructure 306 (e.g., one or more GSM base transceiver stations, base station controllers and mobile switching centers). Persons skilled in the art will appreciate that cellular network access infrastructure 306 may utilize any multiple access architecture, such as for example, a code-division multiple access architecture and/or a time-division multiple access architecture.

Mobile device 302 may, for example, communicate with wireless access point 308 over a wireless interface (e.g., a Bluetooth interface or a Wi-Fi interface). Accordingly, for example, mobile device 302 may access one or more wired networks (e.g., IP network 312 and/or payment network 314) and/or one or more wireless networks 310 (e.g., a mobile network) without the need to first gain access to cellular network access infrastructure 306.

Payment information (e.g., a payment account number and a card expiration date) may be communicated from contactless device 304 to mobile device 302 in support of a transaction (e.g., a financial transaction) being conducted by mobile device 302. In so doing, for example, items for purchase on IP network 312 (e.g., the internet) may be accessed by a browser of mobile device 302 via an access point (e.g., wireless access point 308 and/or cellular network access infrastructure 306). Mobile device 302 may, for example, complete a purchase transaction by first obtaining required payment information from contactless device 304 and then communicating such payment information to network entities (e.g., merchant acquirer 317, payment server 316 and/or issuer 320). Mobile device 302 may, for example, already contain payment information necessary to complete a purchase transaction. Accordingly, mobile device may not need to obtain payment information from contactless device 304 before completing a purchase transaction.

Payment server 316 may, for example, contact issuer 320 via a network (e.g., payment network 314) with payment information received from mobile device 302 for authorization of a purchase. Once authorized, payment transaction information may be recorded onto a receipt that may be delivered to mobile device 302 via any one or more delivery options (e.g., via a short messaging service of mobile network 310 or an email delivery service of IP network 312).

A payment receipt may, for example, be provided to mobile device 302 as a proof-of-purchase object (e.g., a barcode) that may be provided to a display of mobile device 302 and read by other computing equipment (e.g., a barcode scanner) for proof-of-purchase confirmation.

Transaction card 333 (e.g., a powered card, non-powered card and/or device card) may, for example, communicate information to merchant terminal 318 (e.g., a magnetic stripe reader, an EMV reader, an RFID reader, an NFC reader and/or a swipe reader attached to an electronic device). Merchant terminal 318 may begin transactions (e.g., point-of-sale transactions) and/or complete transactions via merchant acquirer 317 and/or payment network 314. Accordingly, for example, transaction card 333 may communicate payment information to merchant terminal 318 to initiate a financial transaction.

Merchant terminal 318 may communicate transaction information, including at least a portion of the payment information, to merchant acquirer 317. Merchant acquirer 317 may authorize the financial transaction and/or communicate with payment server 316. Payment server 316 may, for example, contact issuer 320 via a network (e.g., payment network 314) with transaction information received from merchant acquirer 317 for authorization of a purchase. Once authorized, an authorization may be communicated to merchant terminal 318 and may be recorded onto a receipt by merchant terminal 318.

Application provider 340 may be one or more entities (e.g., one or more servers) providing applications for association in an ecosystem provided by ecosystem provider 342. Each application may provide one or more features to users of a payment method (e.g., users of contactless device 304 and/or transaction card 333). For example, an application may provide a user an opportunity to earn a random reward in exchange for using the payment method. Ecosystem provider 342 may be, for example, a server that maintains associations between applications, users and payment methods.

Ecosystem provider 342 and application provider 340 may communicate with different entities using one or more wired networks (e.g., IP network 312 and/or payment network 314) and/or one or more wireless networks 310 (e.g., a mobile network). Application provider 340 may communicate directly and/or indirectly with different entities. For example, application provider 340 may exchange information (e.g., transactional data) indirectly with issuer 320, merchant acquirer 317 and/or payment network 314 via ecosystem provider 342.

A user electronic device (e.g., mobile device 302 and/or a wired user electronic device 345) may display a GUI. The GUI may be an application manager used to interface with ecosystem provider 342 and application provider 340 to define user preferences. Defining user preferences may include, for example, configuring associations (e.g., between users, applications and payment methods), features and/or permissions.

In order to configure associations, the GUI displayed on the user electronic device may, for example, display indicia representing applications that provide features. A user may associate one or more of the applications to one or more payment cards and/or payment card buttons (e.g., mobile device 302 and/or transaction card 333)).

In order to configure one or more features provided by an application, the GUI displayed on the user electronic device may be used to, for example, interface with application provider 340 to select one or more earnable rewards. For example, using the GUI, a user may select to receive a random reward from among multiple rewards provided by an application hosted by application provider 340.

In order to configure associations, a user may use the GUI displayed on the user electronic device to define how payment network 314, ecosystem provider 342, application provider 340, and third-party applications hosted by one or more application provider 340 (or any other application providing entity) interact for transactions conducted by the user.

For example, a user may accept an end license user agreement that outlines how data may be shared between entities. As another example, a user may define what data may be shared between entities. For example, where data (e.g., transactional data) may be provided to ecosystem provider 342 by payment network 314, and/or provided to application provider 340 by ecosystem provider 342, a user may select at least a portion of data provided to ecosystem provider 342 by payment network 314, and select at least a portion of data to be shared with application provider 340.

Prior to presenting transaction card 333 to merchant terminal 318 to initiate a transaction, a customer may select (e.g., via one or more button presses on a powered card and/or device card) an application to be associated to the transaction. Based on the selection, one or more additional actions may be taken besides the processing of the transaction by payment network 314. For example, a user may press a button on a powered card (e.g., transaction card 333). Upon presenting transaction card 333 to merchant terminal 318, a payment message (e.g., a magnetic stripe message) reflecting the button that was pressed may be communicated to merchant terminal 318. Merchant terminal 318 may communicate a data string including the payment message and transaction information to payment network 314 via merchant acquirer 317.

Payment network 314 may receive the data string. The data string may include a directive instructing payment network 314 to share data with ecosystem provider 342. Payment network 314 may cause the same or a different data string to be communicated from payment network 314 (e.g., from a processor within payment network 314) to ecosystem provider 342.

Although example embodiments describe a payment network communicating data to an ecosystem provider, alternatively and/or additionally, an issuer and/or a processor of an issuer may receive data and communicate a data string based on the data to ecosystem provider 342. For example, a processor of issuer 320 may parse a data string received from merchant terminal 318 (e.g., via payment network 314) that includes a particular BIN number, may convert the data string into a different format and may forward the converted data string to ecosystem provider 342. Persons of ordinary skill in possession of example embodiments will appreciate that many different messaging schemes may be used.

Ecosystem provider 342 may receive the data string and compare user information (e.g., payment account number and/or payment account holder's name) that may be included within the data string to a user database to obtain a customer ID (e.g., a customer token) associated with the user information.

According to at least one example embodiment, sensitive information within the data string (e.g., payment account number and/or payment account holder's name) may be replaced with the customer ID to create a modified data string, and the sensitive information may be stored either locally within ecosystem provider 342 or remotely to ecosystem provider 342. The modified data string may be communicated to a third party application (e.g., application provider 340) via, for example, IP Network 312.

According to at least one example embodiment, ecosystem provider 342 may receive the data string. The data string may be populated with information that may be indicative of which button was pressed on the powered card before being presented to merchant terminal 318. Using the button information and user preferences, ecosystem provider 342 may generate a third-party message with details that may be shared with a third-party application (e.g., application provider 340). The generated data string may include the customer ID and may be communicated to a third party application (e.g., application provider 340) via, for example, IP Network 312.

A user may elect to share certain transaction information with application provider 340 each time a certain button is pressed on the user's powered card before presentment to merchant terminal 318 for payment. Such information may include, for example, merchant information (e.g., merchant's address), date/time information of the purchase, amount of the purchase, type of purchase made, and any other information (e.g., the customer ID associated with the customer's merchant account). The various pieces of the transaction information may or may not be selected for sharing by the user via the user preferences.

According to at least one example embodiment, a user may agree to share data during a registration process with an application provider (e.g., via an end user license agreement). Upon receiving a data string, the sharable data may be automatically populated within a third-party message and communicated to application provider 340 via IP network 312.

Upon receipt of the third-party message, application provider 340 may enact a feature provided to a user (e.g., provide a reward). Application provider 340 may initiate a second transaction (e.g., a piggyback transaction, a statement credit and/or the like). The second transaction may be communicated to ecosystem provider 342 via IP network 312 (e.g., the internet) and processed by ecosystem provider 342 accordingly. For example, ecosystem provider 342 may determine whether a second transaction is permitted and/or forward information associated with the second transaction to another entity (e.g., issuer 320).

According to some example embodiments, a GUI may, for example, be rendered onto a display of a user's card or other device (e.g., mobile device 302, user electronic device 345, transaction card 333 and/or contactless device 304). The GUI may display indicia of one or more third-party applications (e.g., provided by one or more application providers 340) along with summary and/or detailed information. Based upon information gleaned from the information concerning the applications, the user may be better informed as to which third-party applications he or she may wish to associate with his or her powered or non-powered card. Accordingly, the whimsical and festive nature of a user's experience with a GUI rendered by an electronic device may be further enhanced.

According to example embodiments, application provider 340 may be any entity. For example, ecosystem provider 342 may be an application provider in addition to providing an ecosystem. According to at least one example embodiment, an application provider may be a third-party application provider and ecosystem provider 342 may host the third party application. Data sharing may be the same or different based on a particular configuration.

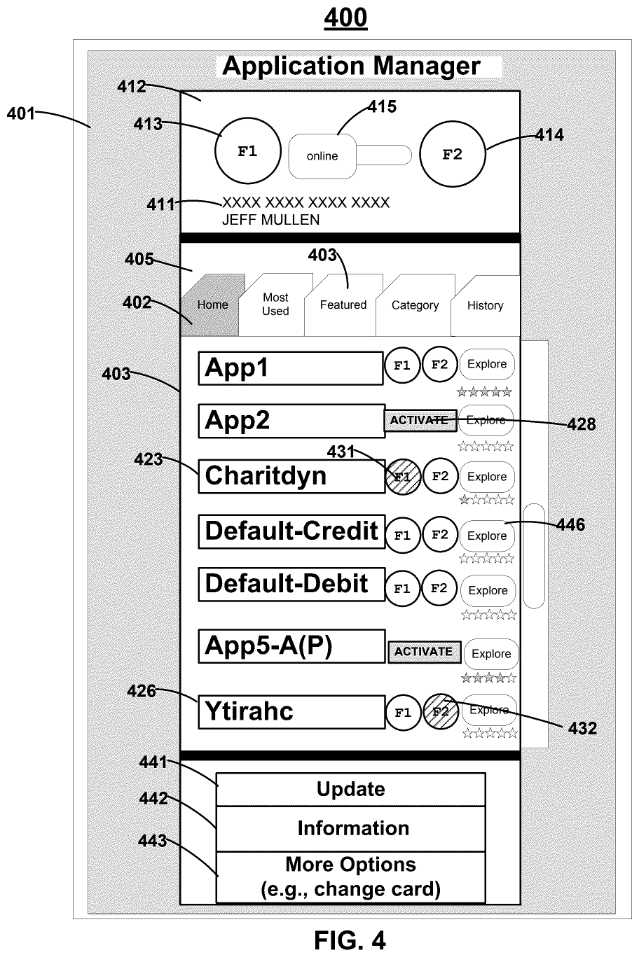

FIG. 4 shows device 400 (e.g., a card, a mobile telephonic device, a laptop computer, a desktop computer or an electronic tablet) that may include display 401. Device 400 may include a processor that may render GUI 403 onto display 401. GUI 403 may be an application manager. Using GUI 403, a user may associate a payment method card (e.g., a powered physical card, non-powered physical card and/or device card) with third party service features within an ecosystem. GUI 403 may be displayed on display 401, for example, a computer monitor, mobile phone touch screen and/or the like. GUI 403 may be, for example, provided as an application for a device (e.g., a computer, a portable computing device and/or a mobile telephonic device) and/or retrieved information from a web browser.

An application manager may be provided, for example, on a remote facility and displayed via GUI 403 to allow a user to change the third party service features associated with a card. An application manager may manage an ecosystem of applications and payment method cards, and the user may utilize GUI 403 to, for example, associate a particular feature to a particular payment method card at any time. The user may associate the selected feature with a card and/or a card button.

Persons skilled in the art will appreciate that a default feature may be provided and/or that a number of features provided by a card issuer or other entity may be provided in addition to third party service features. For example, a card issuer may provide a card with a default of credit on one button and a default of decoupled debit on a second button. A user may press the first button to perform a credit transaction. A user may press the second button to perform a decoupled debit transaction.

GUI 403 may include tabs 405, information 411, virtual card 412, virtual indicia 413 and 414, slider 415, application identifiers 423 and 426, and selection options 428, 431, 432, 441-443 and 446.

Virtual card 412 may be provided as a representation of a user's physical and/or device card. A user may be provided with the ability to change between multiple different cards and configure the features associated with those multiple cards. Accordingly, virtual card 412 may be provided with indicia 413 in the configuration of, and indicative of, one button of a user's card, and virtual card 412 may be provided with indicia 414 in the configuration of, and indicative of, another button of a user's card. Indicia 413 and 414 may display the applications currently associated to each button (e.g., an application icon). A slider 415 may be provided to indicate which of applications associated with a button may be a default application (e.g., for online, telephonic and/or non-powered card transactions). Accordingly, a user may, for example, view virtual card 412 in order to refresh the user's memory with respect to the features associated with the buttons on a user's physical and/or device card.

A list of applications may be provided on GUI 403. Each application may provide one or more third party service provider features. In order to associate a particular feature with a particular card and/or one or more buttons on a card, a user may associate an application providing the feature to the card and/or card button(s). For example, selection 431 may associate application 423 to the button of a card associated with virtual button 413. Selection 432 may associate application 426 to the button of a card associated with virtual button 414. Accordingly, a user may change the features associated to a card by using GUI 403. In order to view the features provided by a particular application the user may, for example, select an “explore” button to view relevant information (e.g., selection 446).

The list of applications provided on GUI 403 may be, for example, all applications or a limited subset of all applications available to a user via an ecosystem provider. For example, in order to view all available applications, tab 402 may be selected by a user (e.g., with a keyboard, mouse, touch sensitive screen and/or electronic pointer) to display an application manager home view. In order to view a limited subset of applications a user may select a different tab. For example, tab 403 may be selected by a user to display a featured view including featured applications (e.g., applications-of-the-week). Other tabs may sort applications by category, use and/or the like.

Selections 428 may be selections used to activate an application with respect to the user. Activation may include registration with a third party application, acceptance of an end users license agreement associated with the application, and/or the like. Activation may also include selecting a particular feature from among multiple features provided by the application. According to at least one example embodiment, some applications may not require activation (e.g., single feature, non-interactive applications).

Once an application is activated and/or associated to a card and/or card button, a user may begin experiencing a selected feature by engaging in card transactions. For example, the user may press a card button associated with a desired feature during a card transaction. A physical and/or device card (not shown) may communicate information indicative of a button that was pressed on the physical and/or device card, along with or separate from other payment data (e.g., an account number, security code, and other data). For example, information indicative of the button that was pressed may be included in discretionary data of a payment message. A payment message may be, for example, one or more tracks of magnetic stripe data (e.g., communicated from a dynamic magnetic stripe communications device), an RFID message (e.g., a near field communication (NFC) message from a radio frequency antenna), and/or an exposed IC chip message (e.g., an EMV message) from an exposed IC chip.

The information indicative of which button was pressed may be passed to a card issuer and/or processor from a point-of-sale and any intermediary devices (e.g., a merchant acquirer processing server). The information may be passed to a remote facility (e.g., a facility providing an application manager) such that the remote facility may determine the button that was pressed by a user. This remote facility may, in turn, retrieve information associated with the third party feature (and/or a feature of a card issuer, processor, application manager provider, and/or any entity) and forward information to that feature provider such that the feature may be performed. Information may additionally and/or alternatively be provided from the feature provider to the entity that provided the information indicative of the button that the user pressed.

Persons skilled in the art will appreciate that if, for example, a non-powered card is utilized then information indicating that a button was pressed may not be available. With respect to a non-powered card, information indicative that a purchase was made may be provided to an application manager provider such that the application manager provider can initiate the desired feature for the non-powered card. For example, the feature may be a default feature, a selected feature (e.g., selected using an application manager) and/or a random feature.

For non-powered cards, for example, features may be associated with different types of purchases. For example, one feature may be provided for a particular merchant type (e.g., a grocer's coupon) and another feature may be provided for a different merchant type (e.g., a memorabilia feature associated with memorabilia dealers). Features may be associated with other characteristics of a purchase such as, for example, a purchase above a particular amount (e.g., at or above $100) and/or a purchase below a particular amount (e.g., below $100). However, such additional feature selections are not limited to non-powered cards and may be provided to, for example, users of powered cards and devices.

GUI 403 may be provided, for example, on a card issuer's and/or application manager provider's website. GUI 403 may be provided, for example, on a bill statement web page. Accordingly, a user may utilize the application manager to manage application features when the user is logged into his/her account. Although example embodiments described with respect to FIG. 4 may describe a GUI 403 used to make various selections and/or associations, persons skilled in the art will appreciate that other methods are possible. For example, selections may be made by phone, email and/or the like.

A third party service provider may utilize GUI 403 as part of a user's administration and/or experience of that third party service. For example, a user's profile page for a third party service may include GUI 403. An application manager provider may provide web-code that retrieves GUI 403 from a remote facility managed by the application manager provider. Selection 441 may be utilized by a user to check for updates (e.g., confirm that a feature was changed and/or if any updates are present). Selection 442 may be utilized to explain the functionality of a particular application feature. Selection 443 may be utilized for additional selection options, for example, changing which card is displayed on an application manager.

According to at least one example embodiment, a card may be provided with one button for a particular payment account (e.g., credit) and one button for a changeable feature. Accordingly, a user may, for example, only need to remember one feature associated with a card. A credit account may include rewards, for example, points, cashback, and/or miles, from the card issuer. Accordingly, pushing the payment account button may earn the user such rewards. Pushing the changeable feature button may, alternatively, for example, not earn the user such rewards and may instead initiate a changeable feature. In doing so, for example, the cost of providing a card may be reduced in that the cost of rewards for the card may be reduced. A feature may include, for example, a feature from a third party application provider. The feature from the third party application provider may be, for example, a random reward (e.g., a random trading card).

Information 411 may, for example, identify the user and card number associated with virtual card 412 and a corresponding physical card. One or more of tabs 405 may provide, for example, a history of purchases made by a user. An application manager may provide indicia reflecting a user rating (e.g., indicated by stars and/or the like).

According to example embodiments, an ecosystem provider may be the same or different from an application manager provider, a remote facility and/or other entities. One or more of the functions described herein as being performed by an application manager provider, and/or other entities, may be performed by the ecosystem provider. According to at least one example embodiment, an ecosystem provider may act as an application manager provider, application provider, issuer, merchant, third party service provider, payment network and/or the like to provide an end-to-end experience. In general, example embodiments contemplate greater or fewer entities, and specific entities are described for purposes of explanation only.

One of ordinary skill in the art will appreciate that GUI 403 is provided for purposes of illustration only and may take various forms. For example, features may be associated to a card without buttons and/or a card may include a fewer or greater number of buttons than depicted in FIG. 4.

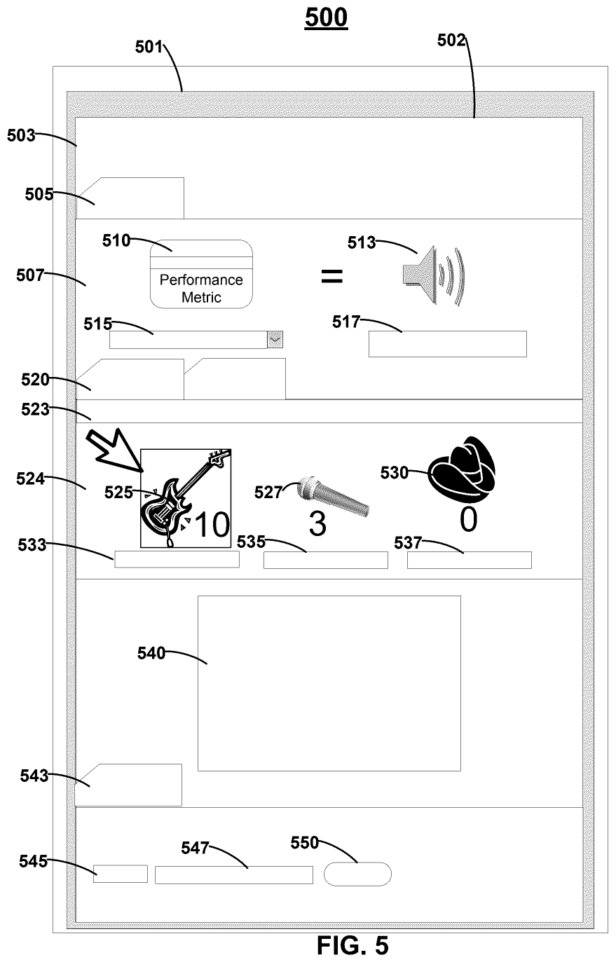

FIG. 5 shows device 500 (e.g., a card, a mobile telephonic device, a laptop computer, a desktop computer or an electronic tablet) that may include display 501. Device 500 may include a processor that may render GUI 502 onto display 501. GUI 502 may be an application interface usable to manage a user's experience with an application. GUI 502 may be used to, for example, configure application settings, receive information from an application provider, and/or communicate information to an application provider.

GUI 502 may include, for example, application screens 503, 507 and 524, tabs 505, 520 and 543, information displays 510, 513, 517, 523, 533, 535, 537, 540 and 545, selections 515 and 550, entry field 547, and progress meters 525, 527 and 530.

Information display 503 may include, for example, information related to an application provider. For example, information display 503 may display the name and a brief history of the application provider.

Application screen 507 may be a configuration screen for an application and may display information explaining a feature provided by the application. For example, application screen 507 may include information indicating that a random reward from a collection of rewards will be provided to the user once the user meets or exceeds a performance metric. The collection of rewards from which a reward is randomly selected may be one of multiple different collections. Accordingly, the user may configure the application by, for example, selecting a collection, from a list of collections, from which to receive a random reward. The performance metric may be, for example, a transactional based performance metric (e.g., completing a number of purchases using a payment card).

Tab 505 may be used to display application screen 507 and may include a descriptor associated with application screen 507 (e.g., “How It Works”). Upon selecting tab 505, application screen 507 may be displayed to a user. Although example embodiments may be described with respect to tabs, persons skilled in the art will appreciate that tabs are used for purposes of explanation only. For example, redirection links may be provided to redirect a user to a configuration screen of an application provider. According to at least one example embodiment, tab 505 may be an information display without tab functionality.

Application screen 507 may include, for example, information displays 510, 513 and 517, and selection 515. Information display 513 may include a representation of a reward, for example, an image representing a type of reward (e.g., an image representing music). Information display 517 may include information associated with information display 513, for example, text indicating that the reward displayed in information display 513 has been or will be randomly selected from a collection of rewards (e.g., a collection of songs). Information display 510 may display a representation of a performance metric, for example, a monetary value and a payment method (e.g., information indicating an amount that must be spent using the payment method to earn a random reward). Selection 515 may, for example, be used to select a collection from which to earn a random reward.

According to at least one embodiment, a collection may not include previously earned rewards such that a user does not receive a duplicate reward. A collection may be earned upon completing a performance metric a number of times equal to a number of rewards in the collection. According at least one other example embodiment, a collection may include previously earned rewards. A collection may not be earned upon completing a performance metric a number of times equal to a number of rewards in the collection.

According to one non-limiting example, an application provider may be a music provider (e.g., a recording studio and/or a music distributor). A user of a payment method (e.g., a powered card) may earn a song each time the user spends an amount indicated in information display 510 using the payment method indicated in display 510. The song may be randomly selected from among all songs made available by the music provider and/or the song may be randomly selected from a music genre chosen by the user using selection 515.

A collection from which a reward may be randomly selected is not limited. For example, where a feature provider is a music provider, a song may be randomly selected from new songs, songs by an artist, songs from a time period (e.g., 80's songs), regional songs (e.g., African songs), and/or songs belonging to a song type (e.g., love songs). Persons of ordinary skill in possession of example embodiments will appreciate that a collection may be variously defined.

Persons of ordinary skill in the art will appreciate that an application may provide value to a user in a variety of ways. For example, a reward provided to a user may be audiovisual (e.g., random videos and/or the like). As another example, a reward may be charitable, such as a random charitable contribution from among a collection of available charitable contributions (e.g., a collection including feeding the hungry, building a well, providing a microloan and/or the like). As yet another example, a reward may be a tangible object (e.g., a random trading card, a random book, a random beverage and/or the like). As still another example, a reward may be a service (e.g., lawn care from a random lawn care provider). As yet still another example, a reward may be randomly selected from a collection including various different types of rewards (e.g., a collection of rewards including songs, videos, books, trading cards, beverages, cruises, charitable contributions, and/or any other feature that may be provided to a user).

Tabs 520 may include one or more tabs used to display one or more application screens 524. For example, tabs 520 may be used to select an application screen displaying redemption codes earned by a user. As another example, tabs 520 may be used to select an application provider screen displaying progress meters associated with earned features. Each progress meter may correspond to a different collection of features. For example, each of progress meters 525, 527 and 530 may be a progress meter including a graphical representation of a collection and an indication of the number of rewards earned from that collection. Information displays 533, 535 and 537 may provide information corresponding to progress meters 525, 527 and 530, respectively (e.g., names of the corresponding collections). A list of each individual feature earned by a user for each collection may be displayed in information display 540.

According to at least one example embodiment, each of information displays 525, 527 and 530 may be selections. For example, a user may select information display 525 to associate the collection represented by information display 525 with a payment method and/or to display a list of features earned from the collection in information display 540. A user may select information display 527 to associate the collection represented by information display 527 with a payment method and/or to display a list of features earned from the collection represented by information display 527 in information display 540. A user may select information display 530 to associate the collection represented by information display 530 with a payment method and/or to display a list of features earned from the collection represented by information display 530 in information display 540. According to some example embodiments, more than one of information displays 525, 527 and 530 may be selected simultaneously. For example, each selected collection may be activated and, upon meeting a performance metric, a feature may be randomly selected from a pool including each of the selected collections.

As one non-limiting example, a tab may be selected to display three icons representing three genres of music from which a user may receive rewards. Each icon may include information indicating the number of songs the user has earned from each genre. A user may select one of the icons to display a list including each song earned by the user from the corresponding genre. However, example embodiments are not limited by the foregoing example. For example, any number of icons may be displayed.

Tab 543 may be selected by a user to display information display 545, entry field 547 and selection 550. For example, tab 543 may be associated to notification settings. Information display 545 may display information with respect to a type of notification (e.g., “email”). Entry field 547 may be used by a user to enter information related to the type of notification (e.g., an email address). Selection 550 may be used to submit the information entered into entry field 547 to, for example, an application provider.

A user may be notified by the application provider when a reward is earned. The application provider may utilize user submitted notification settings to notify the user. For example, a user may submit an email address using entry field 547 and selection 550. A notification email may be sent to the email address when a reward is earned. The email may include a message indicating that the reward has been earned and that a redemption code usable to retrieve the reward is available. Alternatively or additionally, the application provider may attach the redemption code and/or reward to the notification (e.g., embedded in the email). Although example embodiments are described with respect to email, persons of ordinary skill in possession of example embodiments will appreciate that many different notification methods may be used (e.g., telephonic, text messaging, telegram and/or the like). According to at least one example embodiment, no notification may be provided.

As one non-limiting example, a user may receive a text message, telephone call and/or a prompt on their electronic device (e.g., phone and/or MP3 player) indicating that a song has been earned. A user may, for example, press a play button on the electronic device to download and listen to the song.

A selection may be included to activate functionality by which outright purchases of a reward and/or contributions towards a reward may be made (not shown). Purchases and/or contributions may be made using, for example, piggyback charges, third party charges, direct purchases and/or the like.

A piggyback charge may be a statement debit (charge) added to a user statement, for example, for each purchase using a card and/or a device card. A user may select an amount of the piggyback charge using, for example, GUI 502 (not shown). According to at least one example embodiment, a user may earn a reward for each piggy back charge. A third party charge may be a monetary value provided by an application provider, for example, upon a user meeting an additional performance metric (e.g., making purchases at a specific store). A direct purchase may be a partial or complete purchase of a feature by a user that is not attached to any other purchase. For example, a vendor may provide functionality by which a user may swipe a card and/or communicate data of a card to partially or wholly purchase a feature without also purchasing any item from the vendor.

A performance metric may include, for example, a purchase with a card (e.g., a physical and/or device card), a sequence of purchases (e.g., ten purchases), a total amount spent, and/or metrics related to various other purchasing and/or non-purchasing transactional events.

According to some example embodiments, a user may configure an application using GUI 502 to earn rewards not included as a default selection on GUI 502. For example, GUI 502 may include a blank information display (not shown). A feature provider may provide ‘drag-and-drop’ feature icons (e.g., on a feature provider website) representing the reward. A user may drag the icon onto GUI 502 and GUI 502 may be automatically modified to include the feature icon. The icon transfer may include feature provider information, for example, information invisible to a user that may be used by an application. The selected feature may provide special incentives for use of a feature provider's feature, may provide unique features and/or the like.

As one non-limiting example, GUI 502 may display a configurable music application. A user may select from music provided by different music distributors. For example, the user may drag an icon from a webpage of a particular music distributor that provides, for example, songs by a user's favorite artist, onto the configurable application. The user may drag an icon from a webpage of a different music distributor that provides, for example, new music, onto the configurable application. Both icons may appear on the configurable application. Accordingly, an application may not be limited to a specific music provider and may enhance the whimsical and festive nature of a feature provided to a user.

An application accessed using GUI 502 may include configurable functionality to improve a user experience. For example, a representation of each feature earned by the user may be publically and/or privately displayed when earned (and/or a progression display may be updated). For example, feature information may be displayed on a user's social networking page, on a physical display at chosen location and/or the like. In order to provide configurable functionality, an application provider and/or an application of an application provider may be associated to the user during, for example, an activation process. A user requesting access to an application may be prompted for information. The information may include, for example, security credentials used to access a social networking site associated with the user.

Selections may, for example, activate an additional and/or alternative feature. For example, a selection (not shown) may be used to pay an amount corresponding to completion of the performance metric displayed in information display 510. As one example, if a user is required to spend $100 to earn a feature, the value of the feature is $10, and the user has spent $50 using the payment method, the user may pay the feature provider $5 (the difference in value). The amount may be, for example, immediately charged via GUI 502 and/or may be attached as a piggyback charge to a next purchase (e.g., a next purchase using a card and/or a device card).

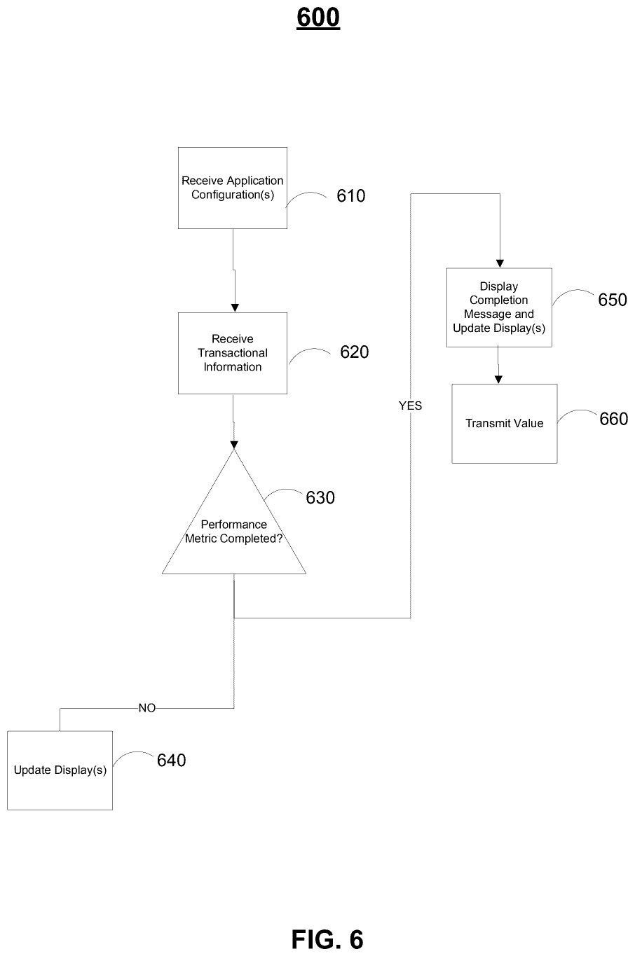

FIG. 6 shows process flow chart 600. An application provider may receive user configuration selections (e.g., as in step 610) and transactional data from, for example, an application manager provider (e.g., as in step 620). The application provider may associate the transactional data with a user and determine if a performance metric has been completed (e.g., as in step 630). If a performance metric has not been completed, the application provider may update one or more information displays based on the received transactional data (e.g., as in step 640). If a performance metric has been completed, the application provider may display a completion message to a user and update one or more information displays (e.g., as in step 650). A value may be transmitted to, for example, the payment method user (e.g., as in step 660).

According to one non-limiting example embodiment, a music provider may receive a user selection of a song genre. The music provider may receive transactional information, for example, information indicative of a feature selected by a user and a number of transactions performed by the user with a payment card. Based on the information, the music provider may determine if a performance metric has been completed. For example, a performance metric may include ten user purchases using a powered credit card. If the user has not completed ten purchases using the powered credit card, a progression display (e.g., a progress meter) may be updated (e.g., if applicable). If the transactional metric has been met, an email may be sent notifying the user that a random song from the song genre selected by the user has been earned. One or more progression displays may be updated and the random song may be communicated to the user. According to at least one example embodiment a redemption code may be communicated to the user. According to at least one other example embodiment, a user may be notified that a redemption code and/or a song is available electronically (e.g., accessed from an application manager).

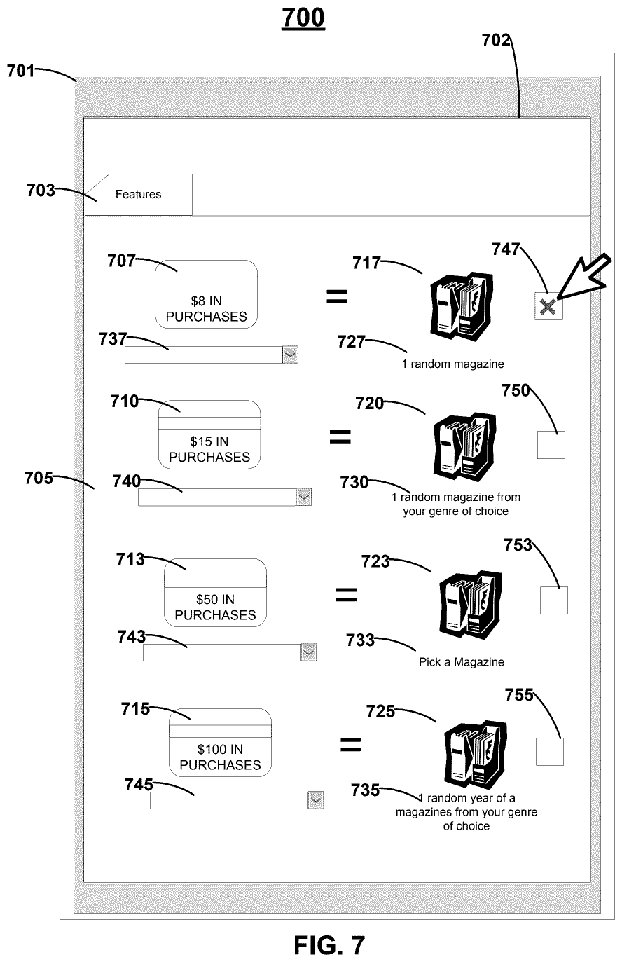

FIG. 7 shows device 700 (e.g., a card, a mobile telephonic device, a laptop computer, a desktop computer or an electronic tablet) that may include display 701. Device 700 may include a processor that may render GUI 702 onto display 701. GUI 702 may be an application interface usable to manage a user's experience with an application. For example, GUI 702 may be used to configure application settings, receive information from an application provider, communicate information to an application provider and/or the like.

GUI 702 may include, for example, tab 703, application screen 705, information displays 707-735 and selections 737-755. Tab 703 may be used to display application screen 705 and may include a descriptor associated with application screen 705 (e.g., “Features”). Upon selecting tab 703, application screen 705 may be displayed to a user. Application screen 705 may be a configuration screen for an application and may include information explaining features provided by the application. For example, application screen 705 may display different configurable, selectable features, along with explanatory information associated with each feature. The features may be configured and/or selected by a user individually, in groups and/or all features may be configured and/or selected.

A feature provided by an application may provide a user selected reward once a user meets or exceeds a performance metric. Alternatively and/or additionally, a feature provided by an application may provide a random reward from a collection of rewards once a user meets or exceeds a performance metric. Accordingly, the user may configure an application by, for example, selecting a feature, selecting a particular reward associated with the feature and/or selecting a collection associated with the feature from a list of collections. The reward may be provided by the application provider upon a user meeting or exceeding the performance metric. An example of a performance metric may include a user completing one or more purchases meeting or exceeding a monetary value using a payment card. The performance metric may be different for different features based on, for example, the value provided by the feature.

Features provided by an application provider may represented by, for example, information displays 707-735 and configured using selections 737-745. For example, information displays 717-725 may each display an image representing a type of reward (e.g., magazines). Information displays 727-735 may each include information associated with information displays 717-735, respectively. For example, information displays 727-735 may display information indicating how a reward will be determined (e.g., selected by a user, randomly selected and/or the like). Information displays 707-715 may each display information associated with a performance metric. The performance metric may be, for example, a transactional based performance metric represented by an image of a payment card and a monetary value.

For example, information displays 707, 717 and 727, and selections 737 and 747, may be associated with a feature. For example, information displays 717 and 727 may include information indicating that a reward may be a magazine randomly selected from all magazines produced by a publisher. Information display 707 may include information indicating that a user may earn the reward by completing $8 in purchases using a particular payment card. Selection 737 may be used to, for example, select a publisher. Selection 747 may be used to, for example, select the feature associated with information displays 707, 717 and 727 as an active feature.

As another example, information displays 710, 720 and 730, and selections 740 and 750, may be associated with a feature. For example, information displays 720 and 730 may include information indicating that a reward may be a magazine randomly selected from a genre of magazines produced by a publisher. Information display 707 may communicate that a user may earn the reward by completing $15 in purchases using a particular payment card. Selection 740 may be used to, for example, select a genre of magazine and/or a publisher. Selection 750 may be used to, for example, select the feature associated with information displays 710, 720 and 730 as an active feature.

As yet another example, information displays 713, 723 and 733, and selections 743 and 753, may be associated with a feature. For example, information displays 723 and 733 may include information indicating that a reward may be a specific magazine selected by the user. Information display 713 may include information indicating that a user may earn the reward by completing $50 in purchases using a particular payment card. Selection 743 may be used to, for example, select a specific magazine (e.g., magazine, issue number and volume). According to at least one example embodiment, selection 743 may redirect a user to an interactive catalog from which a user may select a reward. Selection 753 may be used to, for example, select the feature associated with information displays 713, 723 and 733 as an active feature.

As still another example, information displays 715, 725 and 735, and selections 745 and 755, may be associated with a feature. For example, information displays 725 and 735 may include information indicating that a reward may be a year of magazines from a genre selected by the user. Information display 715 may include information indicating that a user may earn the reward by completing $100 in purchases using a particular payment card. Selection 745 may be used to, for example, select a magazine genre. Selection 755 may be used to, for example, select the feature associated with information displays 713, 723 and 733 as an active feature.

Although example embodiments described in relation to FIG. 7 may include performance metrics based on a monetary value, various other performance metrics are within the scope of example embodiments (e.g., number of transactions, type of transactions, a user acting as a merchant using a particular merchant service and/or the like). Although example embodiments are described with respect to magazines, example embodiments are not limited thereto and may include any type of reward.

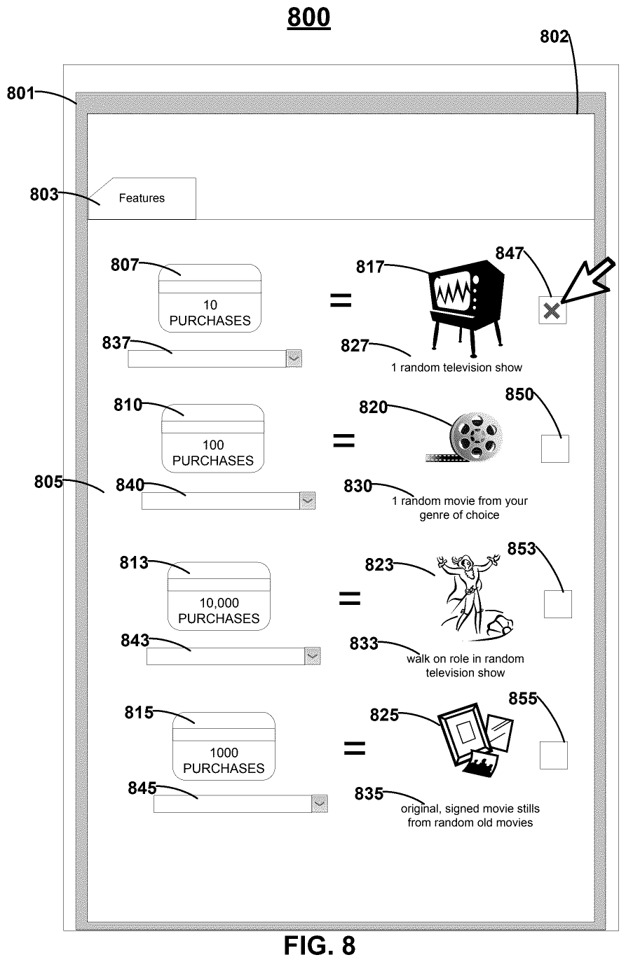

FIG. 8 shows device 800 (e.g., a card, a mobile telephonic device, a laptop computer, a desktop computer or an electronic tablet) that may include display 801. Device 800 may include a processor that may render GUI 802 onto display 801. GUI 802 may be an application interface usable to manage a user's experience with an application. For example, GUI 802 may be used to configure application settings, receive information from an application provider, communicate information to an application provider and/or the like.

GUI 802 may include, for example, tab 803, application screen 805, information displays 807-835 and selections 837-855.

Tab 803 may be used to display application screen 805 and may include a descriptor associated with application screen 805 (e.g., “Features”). Upon selecting tab 803, application screen 805 may be displayed to a user. Application screen 805 may be a configuration screen for an application and may include information explaining features provided by the application. For example, application screen 805 may display different configurable, selectable features, along with explanatory information associated with each feature. The features may be configured and/or selected by a user individually, in groups and/or all features may be configured and/or selected.

A feature provided by an application may provide a user selected reward once a user meets or exceeds a performance metric. Alternatively and/or additionally, a feature provided by an application may provide a random reward from a collection of rewards once a user meets or exceeds a performance metric. Accordingly, the user may configure an application by, for example, selecting a feature, selecting a particular reward associated with the feature and/or selecting a collection associated with the feature from a list of collections. The reward may be provided by the application provider upon a user meeting or exceeding the performance metric. An example of a performance metric may include a user completing one or more purchases meeting or exceeding a monetary value using a payment card. The performance metric may be different for different features based on, for example, the value provided by the feature. According to at least one example embodiment, a feature may not be configurable.

Features provided by an application provider may be represented by, for example, information displays 807-835 and configured using selections 837-845. For example, information displays 817-825 may each display an image representing a type of reward. Information displays 827-835 may each include information associated with information displays 817-835, respectively. For example, information displays 827-835 may display information indicating how a reward will be determined (e.g., selected by a user, randomly selected and/or the like). Information displays 807-815 may each display information associated with a performance metric. The performance metric may be, for example, a transactional based performance metric represented by an image of a payment card and an indication of a number of transactions.

For example, information displays 807, 817 and 827, and selections 837 and 847, may be associated with a feature. For example, information displays 817 and 827 may include information indicating that a reward may be an episode of a television show randomly selected from all television shows produced by a television network, and/or an episode of a television shows that will be produced at some time in the future. Information display 807 may include information indicating that a user may earn the reward by completing 10 transactions using a payment card. Selection 837 may be used to, for example, select a television network. Selection 847 may be used to, for example, select the feature associated with information displays 807, 817 and 827 as an active feature.

As another example, information displays 810, 820 and 830, and selections 840 and 850, may be associated with a feature. For example, information displays 820 and 830 may include information indicating that a reward may be a movie randomly selected from a genre of movies produced by a movie studio. Information display 807 may include information indicating that a user may earn the reward by completing 100 purchases using a particular payment card. Selection 840 may be used to, for example, select a movie genre and/or a movie studio. Selection 850 may be used to, for example, select the feature associated with information displays 810, 820 and 830 as an active feature.

As yet another example, information displays 813, 823 and 833, and selections 843 and 853, may be associated with a feature. For example, information displays 823 and 833 may include information indicating that a reward may be a walk-on role in randomly selected future movie and/or television show. Information display 813 may include information indicating that a user may earn the reward by completing 10,000 transactions using a particular payment card. Selection 843 may be used to, for example, select a movie studio and/or television network. Selection 853 may be used to, for example, select the feature associated with information displays 813, 823 and 833 as an active feature.

As still another example, information displays 815, 825 and 835, and selections 845 and 855, may be associated with a feature. For example, information displays 825 and 835 may include information indicating that a reward may be randomly selected movie stills. Information display 815 may include information indicating that a user may earn the reward by completing 1000 purchases using a particular payment card. Selection 845 may be used to, for example, select a movie still distributor from which to earn the reward. Selection 855 may be used to, for example, select the feature associated with information displays 813, 823 and 833 as an active feature.

According to example embodiments, a reward may be chosen randomly under any of various constraints. For example, a feature may provide a randomly selected reward from the location (e.g., state) in which the user completes a performance metric. As another example, a feature may provide a randomly selected reward based on the time when a performance metric is met (e.g., free breakfast at a random diner when a performance metric is met in the morning).

According to example embodiments, an application provider may receive a monetary value from, for example, an ecosystem provider, an issuer, a merchant and/or a payment network in exchange for providing a random reward to a user. The monetary value may be, for example, a number of basis points ( 1/100 of a percentage point) related to a transaction. According to some example embodiments, an application provider may not receive a monetary value and/or may provide value. The application provider may receive value, for example, via customer acquisition, retention of customers, marketing (e.g., visibility within an ecosystem) and/or the like.

According to example embodiments, a GUI may include a list of information for each random reward previously awarded to a user and rewards that may be obtained by a user (not shown). A collection from which a reward is selected may include sequentially numbered rewards in a manner such that each reward is associated to a particular number. Missing rewards from a collection may be identified (e.g., a reward entry may be missing or grayed out) and/or a user may determine that a collection has been completed. Once a collection is complete, a user may earn a different award (e.g., by redeeming the collection). A collection completion reward may include, for example, a reward belonging to a master collection, a physical item, a virtual collectible and/or the like. The original collection may or may not be removed from the user in exchange for the reward, for example, in exchange for the reward belonging to the master collection (e.g., a master collection may be completed by completing multiple non-master collections). Once a master collection is complete, yet another reward may be earned. As one non-limiting example, if the user has earned a master movie collection, a user may be provided a redemption code redeemable for admittance to the Oscars.

Persons skilled in the art will appreciate that many redemption schemes are possible. According to at least one example embodiment, upon redemption of a collection, one or more rewards may be removed from the user's collection in exchange for a reward. According to at least one example embodiment, upon redemption of a collection, half of the rewards may be removed from the user in exchange for a reward.

According to example embodiments, an electronic reward (e.g., mp3 song) may be transmitted to a user upon completion of a performance metric in various ways. For example, electronic rewards may be distributed using messaging, email, downloads, webpages and/or any other data communication method.

A performance metric may be based on transactional processing. Transactional processing may include multiple stages. For example, a credit transaction may include authorization, batching, clearing and funding. An application and/or feature provider may provide a reward to a user at one of the various stages of transaction processing. In some cases, a transaction may be reversed (e.g., a void or credit) after a user receives a reward based on the transaction. For example, a user may purchase an item, receive an electronic reward and then return the purchased item. According to example embodiments, the application and/or feature provider may be notified by the application manager provider that a transaction has been reversed. A application and/or feature provider may take action based on the notification, for example, provider may reclaim a reward, invalidate a collection code associated to the reward, remove user authorization to use an application and/or feature, and/or the like.

According to some example embodiments, a reward may be granted to a user at a stage of transaction processing (e.g., authorization) but may not be available for use by the user until a different stage of processing (e.g., settlement). If a transaction is reversed (e.g., via a return, a charge-off and/or a charge-back) after being made available to the user the application and/or feature provider may take steps to remove a value associated with the collectable. Accordingly, if a card is used fraudulently (e.g., a stolen card), rewards may be disassociated with a reward system when the purchases are charged-off as a result of the fraudulent spend.

Persons skilled in the art will appreciate that the present invention is not limited to only the embodiments described, and that features described in one embodiment may be used in a different embodiment. The present invention more generally involves dynamic information and devices. 1 Persons skilled in the art will also appreciate that the apparatus of the present invention may be implemented in other ways than those described herein. All such modifications are within the scope of the present invention, which is limited only by the claims that follow.

What is claimed is:

1. A method, comprising:
receiving first information associated with composition of a collection comprising a plurality of collectibles;
receiving second information indicative of which collectibles a first user possesses out of said plurality of collectibles;
displaying images of said collection in a first manner that indicates collectibles possessed by said first user and in a second manner that indicates collectibles missing from said collection; and
automatically changing display of an image of a collectible from said plurality of collectibles from said second manner to said first manner in association with said first user obtaining a new collectible in said collection such that display of said new collectible is in said first manner.

2. The method of claim 1, further comprising:
providing said first user with a reward collectible in association with said first user completing said collection, said reward collectible being one from a plurality of reward collectibles within a reward collection.

3. The method of claim 2, further comprising:
providing said first user with an opportunity to obtain additional reward collectibles from said reward collection.

4. The method of claim 1, further comprising:
providing said first user with an opportunity to trade a completed collection for a first reward collectible from a reward collection.

5. The method of claim 4, further comprising:
providing said first user with an opportunity to trade a completed reward collection for rare reward collectible from a rare reward collectible collection.

6. The method of claim 1, further comprising:
enabling said first user to trade one of its plurality of collectibles for a collectible from a second user.

7. The method of claim 1, wherein said plurality of collectibles comprises a plurality of digital collectibles, further comprising:
storing a first physical collectible that corresponds to a first digital collectible in said first user's collection; and
maintaining an association between said first physical collectible and said first digital collectible, including a physical location of said first physical collectible and a plurality of digital images of said first physical collectible.

8. A system for managing collectibles comprising:
first receiving circuitry operable to receive first information associated with composition of a collection comprising a plurality of collectibles;
second receiving circuitry operable to receive second information indicative of which collectibles a first user possesses out of said plurality of collectibles;
display circuitry operable to display images of said collection in a first manner that indicates collectibles possessed by said first user and in a second manner that indicates collectibles missing from said collection; and
display varying circuitry operable to automatically change display of an image of a collectible from said plurality of collectibles from said second manner to said first manner in association with said first user obtaining a new collectible in said collection such that display of said new collectible is in said first manner.

9. The system of claim 8, further comprising:
reward assignment circuitry operable to provide said first user with a reward collectible in association with said first user completing said collection, said reward collectible being one from a plurality of reward collectibles within a reward collection.

10. The system of claim 9, wherein:
said reward assignment circuitry is operable to provide said first user with an opportunity to obtain additional reward collectibles from said reward collection.

11. The system of claim 8, further comprising:
trading circuity operable to provide said first user with an opportunity to trade a completed collection for a first reward collectible from a reward collection.

12. The system of claim 11, further comprising:
reward trading circuitry operable to provide said first user with an opportunity to trade a completed reward collection for rare reward collectible from a rare reward collectible collection.

13. The system of claim 8, further comprising:
enabling circuitry operable to enable said first user to trade one of its plurality of collectibles for a collectible from a second user.

14. The system of claim 8, wherein said collection comprises a plurality of digital collectibles, said system further comprising:
storing management circuitry operable to associate a first physical collectible with a first digital collectible in said first user's collection, including a physical location of said first physical collectible; and
digital image management circuitry operable to maintain an association between said first physical collectible a plurality of digital images of said first physical collectible.

15. Computing circuitry operable to manage a plurality of collections of collectibles comprising:
collection management circuitry operable to maintain information operable to identify each collectible in each collection of collectibles of said plurality of collections;
user management circuitry operable to maintain a record for each user of which collectibles each user possesses out of each of said plurality of collections each user possesses;
display circuitry operable to display images of each collectible in each of said plurality of collections in a first manner that indicates collectibles possessed by each of users and in a second manner that indicates collectibles missing from each of said plurality of collections; and
display varying circuitry operable to automatically change display of an image of each collectible possessed by a user from said second manner to said first manner in association with said user obtaining a new collectible such that display of said new collectible is in said first manner.
